(19) United States
(12) Patent Application Publication
(10) Pub. No.: US 2026/0313544 A1
(43) Pub. Date: Oct. 8, 2026

(54) COMMON HIBERNATION WAKE-ON-LAN (WoL) PACKET FOR WAKING FOR MULTI-PORT AND STACKED DEVICES

(71) Applicant: Hewlett Packard Enterprise Development LP, Spring, TX (US)

(72) Inventors: Mahendra Reddy Parlapalli, Singapore (SG); Sheau Shian Wong, Singapore (SG); Hsu Htet, Singapore (SG); Hor Yang Lee, Singapore (SG)

(21) Appl. No.: 19/169,839

(22) Filed: Apr. 3, 2025

(51) Int. Cl. H04W 52/02; H04L 61/2596; H04W 84/12

(52) U.S. Cl. CPC H04W 52/0229; H04L 61/2596; H04W 84/12

(57) ABSTRACT

A method may include detecting that a network device is entering a hibernation mode. The method may also involve temporarily programming a plurality of ports of the network device to be associated with a first Media Access Control (MAC) address prior to the network device entering the hibernation mode. The method may also involve receiving a packet that may initiate a wake-up protocol, such that the packet includes a second MAC address. The method may involve determining whether the second MAC address is the same as the first MAC address and initiating the wake-up protocol of the network device in response to determining that the second MAC address is the same as the first MAC address.

### BACKGROUND

Devices connected to a network may occasionally enter a low-power consumption hibernation mode (low-power mode). When operating in this low-power mode, the devices may initiate a wake-up protocol after receiving a magic packet. However, the device may not initiate the wake-up protocol if the magic packet is addressed incorrectly.

### DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example system that includes a network controller in communication with network devices, in accordance with aspects of the present disclosure;

FIG. 2 illustrates an example flow chart of a method for initiating a wake-up protocol in a network device, in accordance with aspects of the present disclosure;

FIG. 3 illustrates an example flow chart of a method for maintaining a record of a common Media Access Control (MAC) address for a network device, in accordance with aspects of the present disclosure;

FIG. 4 illustrates an example flow chart of a method for initiating a wake-up protocol in multiple network devices, in accordance with aspects of the present disclosure;

FIG. 5 illustrates a block diagram illustrating the distribution of a common magic packet to multiple network devices, in accordance with aspects of the present disclosure;

FIG. 6 illustrates components of a network device including a storage and a processing system that executes computer-readable instructions for performing a method for initiating a wake-up protocol in the network device, in accordance with aspects of the present disclosure;

FIG. 7 illustrates components of a network controller including a storage and processing system that executes computer-readable instructions for performing a method for maintaining a record of a common Media Access Control (MAC) address for a network device, in accordance with aspects of the present disclosure; and

FIG. 8 illustrates components of a network device including a storage and a processing system that executes computer-readable instructions for performing a method for initiating a wake-up protocol in stacked network devices, in accordance with aspects of the present disclosure.

### DETAILED DESCRIPTION

For hibernating devices connected to a network, Wake-on-LAN (WoL) corresponds to one method used to wake up the hibernating devices on demand. A network controller may implement a WoL protocol by a sending a magic packet containing the Media Access Control (MAC) address of the network-connected hibernating device to the hibernating device. The network controller may send the magic packet to a network, which may then route the magic packet to the hibernating device. The hibernating device, in turn, may determine whether the address embedded within the magic packet matches the MAC address of a device port that received the magic packet. If the MAC addresses match, the hibernating device may initiate a wake-up protocol and awake from its hibernation mode and return to a normal operation mode in which it actively performs tasks that consume more energy as compared to operating in the hibernation mode.

The WoL protocol described above may perform well for devices that have a single port or where the port connected to the network remains constant, but may not be efficient for a multi-port device, such as a network switch. That is, a network switch may include a number of ports, such that each port may be assigned a different MAC address. As such, when attempting to awaken a hibernating network switch, the network controller may send a magic packet that may include a specific MAC address associated with one of the ports of the network switch. If the port that receives the magic packet corresponds to a WoL-capable port that matches the specific MAC addressed embedded in the magic packet, the network switch may initiate a wake-up protocol (e.g., WoL protocol) to cause the network switch to exit from the hibernation mode. In the same manner, when a stack of multi-port devices, such as network switches in a Virtual Switching Framework (VSF) stack, are put into a hibernation mode, the network controller may send a separate magic packet to each respective WoL-capable port of each multi-port network switch to trigger the wake-up protocol in each respective multi-port device.

In order to ensure that the network controller is capable of awakening any network switch on demand, the network controller may maintain a record of multiple MAC addresses corresponding to the connected WoL-capable ports on each member of the collection of muti-port network switches (stacked network switches). As a result, if the WoL-capable port is reassigned to a different port of a network switch, such that the different port has a different MAC address, the network controller may not be able to wake the respective network switch using the previously assigned MAC address. Instead, each time a port of a network switch is reassigned, the records of MAC addresses employed by the network controller should be updated in order to be able to continue to initiate the wake-up protocol for the respective network switch.

To more efficiently initiate the wake-up protocol for a number of network devices including network switches, the present disclosure includes employing, for example, a network interface system to detect that a corresponding network device is entering a hibernation mode and updating one or more MAC addresses of one or more WoL-capable ports of the network device to a single common MAC address in response to detecting that the network device is entering the hibernation mode. In this way, the network controller attempting to wake the network device may broadcast a single magic packet having the same common MAC address to a number of ports of the network device, such that the network interface system receiving the magic packet at any given port may cause the network device to initiate the wake-up protocol (e.g., activate) upon receiving the magic packet at any of its WoL-capable ports. That is, since each of the WoL-capable ports of the same network device or a collection of stacked network devices is associated with the same common MAC address, a respective network interface system of a network device receiving the magic packet may be triggered to initiate the wake-up protocol and activate the respective network device because the MAC address of the magic packet corresponds to the assigned MAC address of the port that received the magic packet. As a result, a single magic packet having a common MAC address may be used to awaken a network device via multiple different ports. In addition, if the WoL-capable port of the network device is reassigned such that it no longer serves as a WoL-capable port, the same magic packet that was previously used to awaken or activate the network device may still be used to activate the network device via a different WoL-capable port on the same network device.

As may be appreciated, the current techniques provide an improved methodology for waking hibernating devices on demand. Indeed, instead of sending individual magic packets addressed to particular MAC addresses associated with specific WoL-capable ports of certain network devices, the current techniques may enable a single magic packet to be used to activate a hibernating device regardless of which one of the WoL-capable ports receives the magic packet. This feature becomes even more beneficial when applied to stacked network devices in which one common magic packet may be sent to each network device of the stacked network devices to cause any of the stacked network devices to activate. As a result, the network controller used to send the magic packets and initiate the WoL protocol may store less data related to a mapping between different network devices and corresponding MAC addresses of respective WoL-capable ports. In addition, by broadcasting a single magic packet to a number of ports of different network devices, the network controller may awaken the collection of network devices more efficiently, as compared to systematically sending out individual magic packets in series to awaken the collection of network devices.

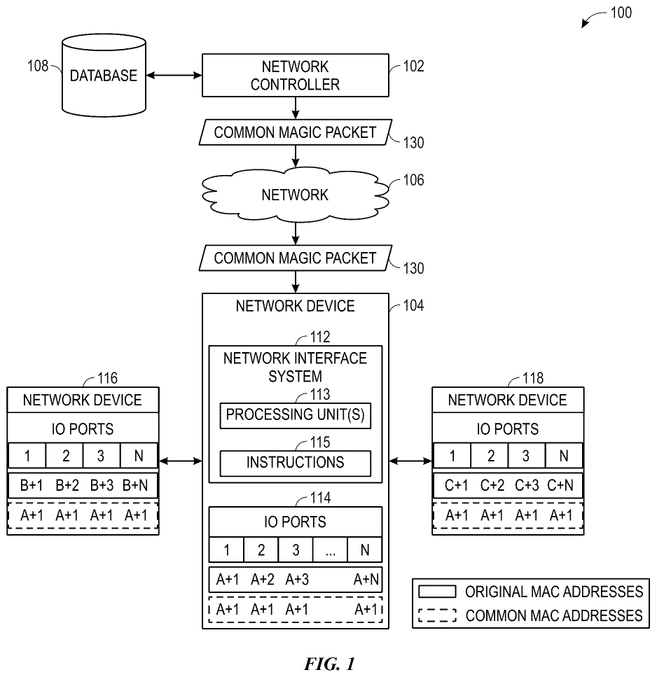

By way of introduction, FIG. 1 illustrates a system 100 in which a network controller 102 may send a signal or data packet to a network device 104 to cause the network device 104 to initiate a wake protocol. The network controller 102 may include any suitable processing system that may coordinate operations with network devices across a network 106. The network controller 102 may be part of a server system or some other processing system that manages network functions, such as routing communication packets, maintaining security, configuring devices, and the like. The network controller 102 may be implemented via hardware (e.g., electronic circuitry) or a combination of hardware and programming (the combination comprising, e.g., at least one processor and instructions executable by the at least one processor and stored on at least one machine-readable storage medium).

The network 106 may include any suitable network that facilitates communication between network devices, computing systems, electronic devices, and the like. The network 106 may enable various network devices to exchange data and share resources between each other. By way of example, the network 106 may include routers, switches, and other traffic directing devices to control the flow of data between senders and recipients. The network 106 may include a wired network, a wireless network, or both. For instance, the network 106 may include a Local Area Network (LAN), a Wide Area Network (WAN), the Internet, an Intranet, and the like.

The network device 104 may include at least one processing resource, at least one non-transitory machine-readable storage medium, and corresponding instructions. In some examples, the network device 104 may be a network switch, a router, or any other suitable multi-port device. In some implementations, the network device 104 may include a number of components to perform the various operations described herein. For example, the network device 104 may include a network interface system 112, one or more input/output (IO) ports 114, one or more processing units, a communication component, and other components not illustrated herein.

The network interface system 112 may operate as the communication component for the network device 104 by managing communications received by and sent from the network device 104. As such, the network interface system 112 may also include at least one processing resource, at least one non-transitory machine-readable storage medium, and corresponding instructions. In some examples, the network interface system 112 may be a wireless or wired communication component that facilitates communication between the network device 104 and any other suitable electronic device. The processing resource of the network interface system 112 may include one or more processing units 113, such as a baseband processor, to perform certain operations as described herein based on corresponding instructions 115, which may be stored in the at least one non-transitory machine-readable storage medium. The processing units 113 of the network interface system 112 may be separate from the processing units of the network device 104. However, it should be noted that, in some cases, the processing units of the network device 104 may also be used to control operations of the network interface system 112 or may be used in conjunction with the processing units 113 to perform various operations. Each of the processing units 113 may include multiple processor devices that may be of any type of computer processor or microprocessor capable of executing computer-executable code.

In some implementations, the network interface system 112 may coordinate the reception and transmission of data packets between the network device 104 and other separate devices. As such, the network interface system 112 may function as a transceiver component within the network device 104 and coordinate the reception and transmission of data packets to and from the network device 104.

The IO ports 114 may provide access to one or more devices to facilitate human or machine interaction with the network device 104. In addition, the IO ports 114 may communicatively couple to or facilitate communication with other devices via the network interface system 112, the network 106, or the like. Each of the IO ports 114 may be assigned a unique Media Access Control (MAC) address by the network interface system 112 or other suitable processing system that may be part of the network device 104. As such, data packets transmitted to the network device 104 may include an address corresponding to a MAC address of a destination port of the IO ports 114.

Although a certain set of components are depicted with respect to the network device 104, it should be noted that the network controller 102 or any other computing or processing device described herein may also include the same or similar components to perform, or facilitate performing, the various operations described herein. Moreover, it should be understood that the components described above are exemplary figures and the network device 104 and other suitable computing systems may include additional or fewer components as detailed above.

In some instances, the network device 104 may enter a low-power or hibernation mode of operation after some period (e.g., greater than a threshold amount of time) of inactivity experienced by the network device 104. The hibernation mode may be a power-saving feature that may involve saving a computational state of the network device 104 in a memory component and causing the network device 104 to operate in a low-power consumption mode for a period of time. To exit out of the hibernation mode, the network device 104 may receive a magic packet, which may be a network data packet used in in a Wake-on-LAN (WoL) protocol to cause the network device 104 to remotely wake up from the hibernation mode (e.g., low-power state).

The network data packet used to wake the network device 104 may be referred to as a magic packet or a WoL magic packet. By way of operation, to wake or initiate a wake-up protocol of the network device 104, the magic packet may include a MAC address corresponding to a port of the network device 104 being awakened. For example, each MAC addresses for each of the IO ports 114 may include a base MAC address (“A”) and a unique identifier (“1, 2, 3 . . . . N”). As such, after the network interface system 112 receives the magic packet via a particular IO port 114 (e.g., having A+1 MAC address), the network interface system 112 may determine whether the magic packet includes the MAC address (e.g., A+1) corresponding to a particular IO port 114 (e.g., WoL-capable port, WoL-supported port) that received the magic packet. If the network interface system 112 confirms that the MAC address of the magic packet matches the MAC address associated with the IO port 114 that received the magic packet, the network interface system 112 may initiate a wake-up protocol to cause the network device 104 to exit the hibernation mode and enter a normal operating mode, which may correspond to performing operations that consume a higher amount of power as compared to operating in the hibernation mode.

The foregoing description of initiating the wake-up protocol may work well when the network device 104 has just one IO port 114 or when the IO port 114 connected to the network 106 does not change. However, this process may not work well with multi-port devices in which the IO port 114 connected to the network 106 may change. To ensure that the network controller 102 is capable of initiating wake-up protocols for hibernating network devices, the network controller 102 may maintain a record of MAC addresses corresponding to WoL-capable ports for each device (e.g., network device 104, network devices 116 and 118) connected to the network controller 102. However, maintaining this record may become challenging as more devices are connected to the network 106, as WoL-capable ports are reassigned, and the like.

As such, in some implementations, prior to the network device 104 entering the hibernation mode, the network device 104 (e.g., via the network interface system 112) may reprogram or modify the MAC addresses of each of the IO ports 114 to a common MAC address (e.g., A+1), which may combine a base MAC address (e.g., A) of the network device 104 and an identifier (e.g., 1) corresponding to one of the IO ports 114. For example, the network controller 102 may store information regarding the IO ports 114, a respective network device 104 associated with the IO ports 114, the original MAC addresses for the IO ports 114, the corresponding common MAC for the IO ports 114, and the like in a table (e.g., lookup table), a database 108, or other suitable storage. In this way, the network controller 102 may maintain a record of common MAC addresses to use to initiate wake-up operations for different network devices along with the original MAC addresses.

The network device 104 may detect or determine that the network device 104 may be entering the hibernation mode after a counter measuring the inactivity of operations (e.g., processes, computations, communications) reaches some threshold value, after a threshold amount of time of inactivity is detected in the network device 104, and the like. For example, the network device 104 may employ a counter to track a number of instructions executed within a period of time, a number memory accesses served within the period of time, a number of clock cycles that expire within the period of time without performing a processing operation, and the like. If the counter reaches a threshold count, the network device 104 may enter the hibernation mode. As such, the network device 104 may anticipate that it will enter the hibernation mode when the counter reaches within a range of the threshold count.

In another example, the network device 104 may monitor an amount of power consumed, an amount of time that passes after an instruction has been executed, and the like to determine that the network device 104 may be entering the hibernation mode. After the network device 104 reaches some threshold related to the monitored property, the network device 104 may enter the hibernation mode. As such, the network device 104 may anticipate that it will enter the hibernation mode when the monitored property is within a range of the threshold.

In addition, the network interface system 112 may monitor certain operations of the network device 104 and determine a time at which the network device 104 may enter a hibernation mode. That is, the network interface system 112 may track active operations or processes performed by processors of the network device 104, inputs received via the IO ports 114, data packets transmitted or received via the IO ports 114, or other tasks performed by the network device 104 over a period of time. If the network interface system 112 detects that network device 104 has not performed any tasks for over a threshold amount of time, the network interface system 112 may determine that the network device 104 may be entering the hibernation mode. Prior to entering hibernation mode (e.g., prior to reaching the threshold amount of time), the network interface system 112 may modify the MAC addresses of each of the IO ports 114 to a common MAC address (e.g., A+1). By way of example, FIG. 1 illustrates how each of the IO ports 114 of the network device 104 may be changed to the common MAC address, A+1, which may correspond to one of the original MAC addresses assigned to one of the IO ports 114.

The common MAC address may be pre-selected by the network interface system 112, previously communicated to the network controller 102, previously defined within the network controller 102 and the network interface system 112, or the like. In some implementations, the network interface system 112 may maintain an association or mapping between each IO port 114 and a respective MAC address. As such, after detecting that the network device 104 may be entering the hibernation mode, the network interface system 112 may update a record of mappings between each IO port 114 and a corresponding MAC address to indicate that each of the IO ports 114 correspond to or are mapped to the common MAC address.

In some implementations, to keep the network controller 102 apprised of the common MAC address, the network device 104 may send a notification to the network controller 102 indicative of the common MAC address, such that the network controller 102 may store the common MAC address and an association with the respective network device 104 in the database 108 or any other suitable storage component. The database 108 may be directly accessible to the network controller 102, indirectly accessible to the network controller 102 via the network 106, or the like. The database 108 may store a collection of common MAC addresses for different devices, such that the network controller 102 may identify an appropriate common MAC address for a respective network device 104, 116, or 118 to be awakened. Although the database 108 is illustrated as being separate from the network controller 102, the database 108 may also be part of the network controller 102.

After the network device 104 enters the hibernation mode, the network controller 102 may broadcast a common magic packet 130 that may include the common MAC address to the network devices 104, 116, and 118 via the network 106. In this way, each of the IO ports of any network-connected device may receive the common magic packet 130. After receiving the common magic packet 130, the network interface system 112 may confirm that the individual IO port 114 that received the magic packet has a matching MAC address as the MAC address as provided in the common magic packet 130. In response to determining that the two MAC addresses match, the network interface system 112 may initiate the wake-up protocol to cause the network device 104 to exit the hibernation mode and resume operations at higher power consumption rates. After the network device 104 resumes its normal operation mode, the network interface system 112 may reprogram or reassociate each of the IO ports 114 with the original MAC address previously assigned to each IO port 114. In this way, communications directed to each respective IO port 114 may be received and processed accordingly. However, while operating in the hibernation mode, the network device 104 may disregard these messages since the IO ports 114 are assigned to the common MAC address.

As discussed above, in addition to the network device 104, the system 100 may include additional network devices 116 and 118 that may communicate with the network controller 102. In some implementations, the network devices 116 and 118 may include server systems, processing systems, mobile computing devices, remote computing devices, network switches, routers, and the like. The network device 104 may be stacked with the network devices 116 and 118 to form a Virtual Switching Framework (VSF) stack. The VSF stack may enable multiple network devices to be connected or stacked with each other to operate as a single logical device. In some implementations, the network devices 104, 116, and 118 may be stacked to form the VSF stack, such that each of the network devices 104, 116, and 118 are collectively operating in either a normal mode or a hibernation mode. As such, when one of the stacked network devices (e.g., network device 104) enters the hibernation mode, the remaining stacked network devices (e.g., network devices 116 and 118) may also enter the hibernation mode. In this case, each of the network devices 104, 116, and 118 may also modify the MAC address of each of its respective IO ports to the common MAC address prior to entering the hibernation mode when operating in the VSF stack. As a result, the same common magic packet may be used to awaken each of the network devices 104, 116, and 118 in the VSF stack. It should be noted that although only three network devices are depicted in FIG. 1, it should be understood that the system 100 may include any suitable number of network devices that may communicate with the network controller 102 and may be stacked with the network device 104.

Further, although the foregoing description details using MAC addresses with IO ports 114, it should be noted that other network addresses may be used instead of MAC addresses in accordance with the techniques described herein. For example, each IO port 114 may be associated with an Internet Protocol (IP) address or other suitable address types.

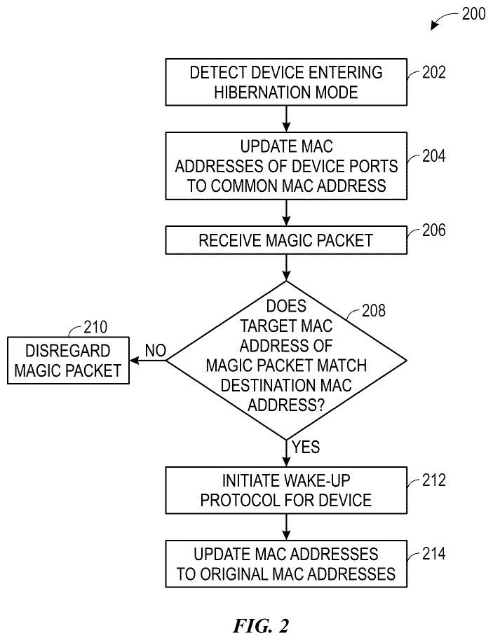

FIG. 2 illustrates a method 200 for initiating a wake-up protocol, in accordance with techniques described herein. In some implementations, the method 200 may be performed by the network interface system 112 of the network device 104, however, it should be noted that the method 200 may be performed by any suitable processing system of any suitable network device. In addition, although the method 200 is described as being performed in a particular order, it should be understood that the method 200 may be performed in any suitable order.

Referring now to FIG. 2, at block 202, a network device may detect that it may be entering a hibernation mode. The network device may monitor processes performed by a corresponding processing unit, data received via a communication component, or other operations performed by the network device to determine whether the network device is inactive. That is, after the network device has stopped actively performing certain processing tasks (e.g., computations, memory calls, communications) for a threshold of time, the network device may determine that it may be entering the hibernation mode. It should be noted that the network device may automatically enter the hibernation mode after a certain condition (e.g., inactivity time exceeds a threshold amount of time). As such, the network device may detect that it will enter the hibernation mode at a particular time, which will be prior to it entering the hibernation mode.

At block 204, after detecting that it may be entering the hibernation mode, the network device may update the MAC addresses of each of its IO ports (e.g., WoL-capable ports) to a common MAC address. For example, the network device may include three IO ports having original MAC addresses of “A+1”, “A+2”, and “A+3”. The MAC address may thus include a base MAC address “A” and an identifier “1”, “2”, or “3”. The common MAC address may be pre-defined by a network controller communicatively coupled to the network device, a network interface system of the network device, a processing unit of the network device, or the like. In some implementations, the network device may select the common MAC address, such as one of the original MAC addresses already assigned to one of the IO ports.

To update the MAC addresses of the IO ports of the network device, the network device may update a record of the MAC addresses for the IO ports in a table (e.g., look-up table), memory, database, or the like. Continuing the example from above, the network device may define the common MAC address as “A+1” and may send the common MAC address “A+1” to the network controller. Table 1 provides an example record of mappings between the three MAC addresses for the IO ports and the common MAC address described in the example provided above.

TABLE 1
Network Device A

| Original MAC Address | Common MAC Address |
|---|---|
| A + 1 | A + 1 |
| A + 2 | A + 1 |
| A + 3 | A + 1 |

After selecting the common MAC address, the network device may send a notification of the selected common MAC address to the network controller, which may update a mapping between the common MAC address and the connected network device. For example, the network controller may maintain a record of the common MAC address for the network device similar to the Table 1 example provided above.

After the network device updates the MAC addresses of the IO ports to the common MAC address, the network device may enter the hibernation mode. As such, with the example common MAC address discussed above, each of the IO ports of the network device may be assigned to the common MAC address “A+1”. During the hibernation mode, the network device may refrain from performing certain processing operations, transmitting data via the communication component, receiving data via the communication component, and other resource consuming operations. The hibernation mode may thus enable the network device to perform minimal operations that limit or reduce the amount of power consumed by the network device.

At block 206, the network device may receive a magic packet from the network controller or other suitable device to cause the network device to exit the hibernation mode. The magic packet may be a WoL packet designed to cause the network device to initiate a wake-up protocol for the network device regardless of which IO port receives the magic packet. As mentioned above, the magic packet may include a MAC address (target MAC address) that corresponds to a destination IO port. Continuing the example from above, the magic packet may include a MAC address of “A+1” and may be received by any of the IO ports of the network device to initiate the wake-up protocol.

At block 208, the network device may determine whether the target MAC address of the magic packet matches the MAC address of the destination IO port that received the magic packet. If the target MAC address does not match the MAC address of the destination IO port, the network device may proceed to block 210 and disregard the magic packet.

On the other hand, if the target MAC address matches the MAC address of the destination IO port, the network device may proceed to block 212 and initiate the wake-up protocol for the network device. As mentioned above, the network device may have updated each of its IO ports to be associated with the common MAC address. In this way, if the magic packet received by any of the IO ports of the network device includes the common MAC address, the network device may proceed to block 212 and initiate the wake-up protocol for the network device.

At block 212, the network device may initiate a wake-up protocol for the network device. As such, the network device may restore its operational state to a previous state that the network device was operating prior to entering the hibernation mode. In some implementations, the network device may execute instructions or a command to cause it to exit the hibernation mode and resume operations corresponding to the previous state. After exiting the hibernation mode, the network device may, for example, resume executing certain computational processes and facilitate communications with other devices.

At block 214, the network device may update the MAC addresses of its IO ports, such that they correspond to the original MAC addresses or other suitable different or unique MAC addresses. As a result, each IO port may resume receiving communications from devices intending to communicate with the network device via the respective IO ports. The network device may then update the mapping of the IO ports to the original MAC addresses in its records, memory, or the like. Referring again to the example MAC addresses discussed above, the network device may update the mapping of the IO ports to revert back to the original MAC addresses using the information stored in Table 1. As such, each IO port will revert back to its respective original MAC address.

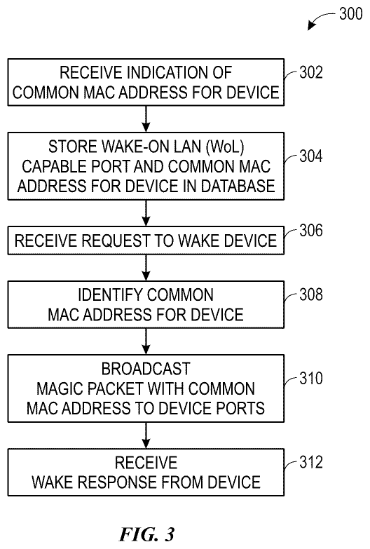

While the manner in which a network device operates when entering and leaving hibernation mode has been described above with reference to FIG. 2, FIG. 3 illustrates a flow chart of a method 300 that a network controller (e.g., network controller 102) may perform with regard to the network devices (e.g., network devices 104, 126, and 128) entering and leaving the hibernation mode. That is, as different network devices enter hibernation modes, a network controller corresponding to these network devices may update a record of MAC addresses, such that the different MAC address of each IO port of each network device is now associated with a common MAC address assigned to each IO port of each network device. As such, a magic packet including the common MAC address may be used to initiate a wake-up protocol for any of the network devices. Before referring to FIG. 3, it should be noted that although the method 300 is described as being performed in a particular order, it should be noted that the method 300 may be performed by any suitable device in any suitable order.

Referring now to FIG. 3, at block 302, the network controller may receive an indication of a common MAC address for a network device. The common MAC address may be received from the network device after the network device initially connects with the network controller via a network. The network device may send the common MAC address after the network device updates the addresses of its IO ports in response to detecting that it may be entering the hibernation mode. In some implementations, the common MAC address for the one network device and for different network devices may be predefined and stored in a database or other suitable storage component accessible to the network controller, the network device, or the like.

After receiving the indication of the common MAC address, at block 304, the network controller may store information regarding one or more IO ports (e.g., WoL-capable ports), a respective network device, and the corresponding common MAC address assigned to the IO ports in a table, the database, or other suitable storage. In this way, the network controller may maintain a record of common MAC addresses to use to initiate wake-up operations for different network devices. For example, the common MAC addresses for network devices “A”, “B”, and “C” may be stored as Table 2 provided below.

TABLE 2

| | Network | Network | Network |
|---|---|---|---|
| | Device A | Device B | Device C |
| Common MAC Address | A + 1 | B + 1 | C + 1 |

At block 306, the network controller may receive a request to wake one or more network devices. For example, the network controller may receive a request to initiate a wake-up protocol for the network devices via a user input, an automated input generated based on detecting conditions (e.g., alarm), and the like. The request may be received via a local input entered directly via the network controller of via a remote input received via the network. Keeping the example mappings of Table 2 in mind, the network controller may receive a request to wake network device B.

After receiving the request to wake the network devices, at block 308, the network controller may identify the common MAC address for the network devices associated with the request received at block 306. In some implementations, the network controller may query the database, the table, or other suitable storage component to identify the common MAC address associated with the network devices specified in the request. Referring to the example above, the network controller may query Table 2 and identify the common MAC address for network device B as “B+1”.

At block 310, the network controller may broadcast a magic packet with the common MAC address to each of the network devices connected to the network controller. As such, the magic packet with the common MAC address may be sent to the multiple network devices simultaneously through multiple communication channels. After receiving the broadcast magic packet at the multiple network devices, each respective network device may initiate the wake-up protocol or activate in response to determining that the IO port that received the magic packet has a matching MAC address as the common MAC address.

Again, referring to the example above, the magic packet may include the common MAC address “B+1”. As such, after being broadcast to multiple network devices, such as network device A, network device B, and network device C, the magic packet may be received by each respective network device. However, since the magic packet includes the common MAC address “B+1”, network devices A and C may disregard the magic packet because each of its respective IO ports do not have a matching MAC address as the common MAC address “B+1”. On the other hand, the network device B may initiate the wake-up protocol after confirming that the IO port that received the magic packet includes the same MAC address as the MAC address within the magic packet.

At block 312, the network controller may receive a wake response from the network device that received the magic packet via the IO port having the common MAC address. That is, after the network device initiates the wake-up protocol in response to confirming the common MAC address matches the MAC address of the IO port 124 that received the magic packet, the network device may send a wake response packet to the network controller confirming that the network device received the magic packet, initiated the wake-up protocol, has activated, or the like.

After receiving the wake response, the network controller may resume communicating with the network device using the MAC addresses previously assigned to or newly assigned to the IO ports. As such, the network controller may maintain a record of the original MAC addresses and the common MAC addresses assigned to each port as described with respect to Table 1. In this way, the network device may resume normal operations and perform processes and facilitate requests provided by the network controller and the like.

As mentioned above, the network device may be stacked with or connected to other network devices to operate as a Virtual Switching Framework (VSF) stack. In some implementations, network devices may be stacked to form the VSF stack, such that each of the stacked network devices operate in a normal mode or in a hibernation mode. To minimize the number of magic packets used to cause each of the stacked network devices to exit its hibernation mode, one of the stacked network devices may communicate the common MAC address to the other stacked network devices. That is, prior to one network device entering the hibernation mode, the network device entering the hibernation mode may communicate the common MAC address assigned to its IO ports to the other stacked network devices. In this way, the other stacked network devices may program their respective IO ports to the common MAC address prior to all of the stacked network devices entering the hibernation mode.

For example, network device A, network device B, and network device C may be stacked network devices. As such, prior to entering the hibernation mode, the network device A may send the common MAC address “A+1” to the network device B and the network device C. In turn, network devices B and C may update the MAC addresses of each of its respective IO ports to the common MAC address “A+1”.

By programming all of the IO ports of each of the stacked network devices to the common MAC address, a network controller may minimize the record of the mappings between the MAC addresses and corresponding IO ports of different network devices. Moreover, the network controller may use just one common magic packet to wake any or all of the stacked network devices.

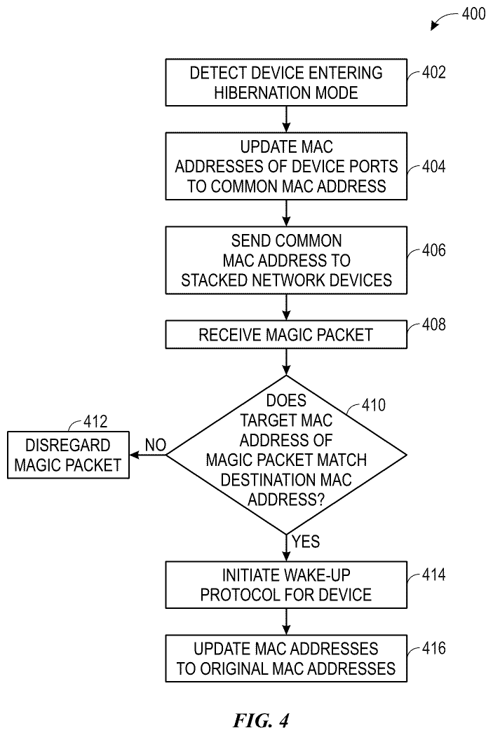

FIG. 4 includes a flow chart of a method 400 for initiating the wake-up protocol for a network device when operating as a part of a set of stacked network devices. Although the following description of the method 400 is described as being performed in a particular order, it should be noted that the method 400 may be performed in any suitable order.

Referring now to FIG. 4, blocks 402 and 404 may correspond to blocks 202 and 204 of the method 200 described above. That is, one of the stacked network devices may detect that it is entering a hibernation mode and may update the MAC addresses of its IO ports to a common MAC address in response to detecting the change to the hibernation mode. By way of example, network devices A, B, and C may operate as a set of stacked network devices. After network device A detects that it is entering the hibernation mode, it may update its IO ports to be associated with the common MAC address “A+1”.

At block 406, after updating the MAC address of its IO ports, the one network device may send the common MAC address assigned to its IO ports to the other stacked network devices. In turn, the other stacked network devices may update their respective IO ports to be associated with (e.g., assigned to) the common MAC address of the one network device that sent the common MAC address. As a result, the same common magic packet may be used to wake all of the stacked network devices. In some implementations, the common MAC address may be pre-defined for each of the stacked network devices, such that each of the stacked network devices may program the corresponding IO ports to the pre-defined common MAC address prior to any of the stacked network devices entering the hibernation mode. Continuing the example above, the network device A may send the common MAC address “A+1” to network devices B and C. In turn, network devices B and C may update the MAC addresses of its IO ports to be associated with the common MAC address “A+1”.

At block 408, the one network device may receive the magic packet with the common MAC address. As discussed above, the magic packet may be broadcast to each of the stacked network devices from the network controller. As such, in addition to the one network device receiving the magic packet, each of the other stacked network devices may also receive the magic packet with the same common MAC address. At block 410, the one network device may determine whether the common MAC address of the magic packet matches the MAC address of the IO port that received the magic packet. If the MAC addresses do not match, the one network device may proceed to block 412 and disregard the magic packet.

On the other hand, if the MAC addresses match, the one network device may proceed to block 414 to initiate a wake-up protocol and update the MAC addresses of its IO ports back to the original MAC addresses, to new MAC addresses, or the like. It should be noted that any of the stacked network devices may perform similar operations as described above in blocks 408, 410, 412, 414, and 416 after receiving the magic packet.

Continuing the example provided above, the magic packet may be received by the network devices A, B, and C. Since the IO ports of each of the network devices A, B, and C are associated with the common MAC address “A+1” provided within the magic packet, each network device A, B, and C may initiate the wake-up protocol and update the MAC addresses of its IO ports accordingly.

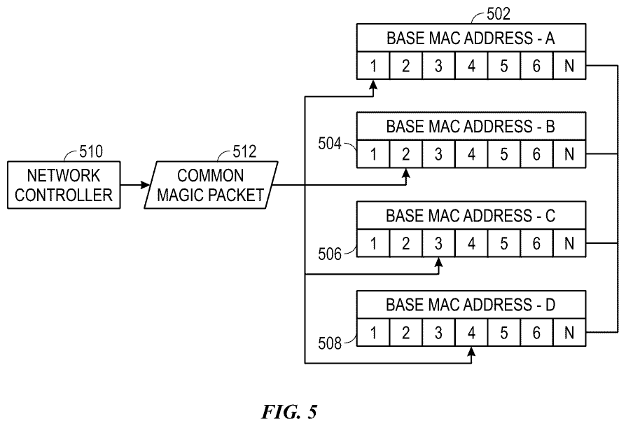

FIG. 5 illustrates an example network device 502 stacked with three other network devices 504, 506, and 508 in accordance with the techniques described herein. In some implementations, the network device 502 may be connected to each of the network devices 504, 506, and 508 via different IO port connections, separate communication ports, or the like. By sharing these connections with each other, the stacked network devices (e.g., network devices 502, 504, 506, and 508) may be able to locally communicate with each other and operate as a single device. A network controller 510 may be coupled to a single IO port for each network device 502, 504, 506, and 508. As such, when the network controller 510 broadcasts a common magic packet 512 to certain IO ports of the network devices 502, 504, 506, and 508, each of the corresponding network devices 502, 504, 506, and 508 may initiate the wake-up protocol if the MAC address of the common magic packet 512 matches the MAC address of the IO port that received the common magic packet 512.

As shown in FIG. 5, the common magic packet 512 may be broadcast to multiple network devices 502, 504, 506, and 508 and received at different IO ports corresponding to the different network devices 502, 504, 506, and 508. Each respective network device 502, 504, 506, and 508 may have a unique base MAC address. The base MAC address may be a 48-bit hexadecimal number used to identify a particular device on the network. The base MAC address may be used as a portion of a MAC address used to identify an IO port of a respective network device. As such, each IO port of a network device may have a unique identifier relative to the network device and an additional unique identifier relative to a respective IO port. In one example, the unique identifier for each respective IO port may be appended to the base MAC address to form a unique MAC address for the respective IO port.

As discussed above, the network device 502 may communicate the common MAC address to the network devices 504, 506, and 508 prior to entering the hibernation mode. Alternatively, each network device 502, 504, 506, and 508 may refer to a pre-defined common MAC address to use to program its IO ports prior to entering the hibernation mode. As such, each of the network devices 502, 504, 506, and 508 may have temporarily reprogrammed the MAC addresses of the respective IO ports to be the same as the common MAC address prior to entering the hibernation mode. In this way, the same common magic packet 512 may be used to initiate the wake-up protocol for each of the network devices 502, 504, 506, and 508, thereby reducing the amount of memory used to maintain a record of the mapping between the MAC addresses and corresponding IO ports of the network devices 502, 504, 506, and 508.

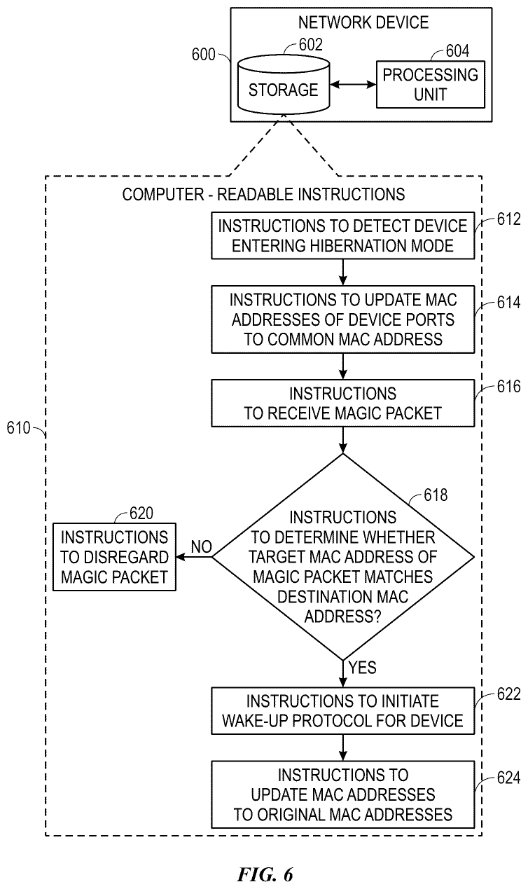

FIG. 6 illustrates components of an example network device 600 that may include a storage 602 and a processing unit 604. The storage 602 may be any suitable article of manufacture that may serve as media to store processor-executable code, data, or the like. These articles of manufacture may represent computer-readable medium/media (i.e., any suitable form of memory or storage) that may store the processor-executable code used by processing units to perform the presently disclosed techniques. The storage 602 may represent non-transitory computer-readable medium/media (e.g., any suitable form of memory or storage) that may store the processor-executable code used by the processing units to perform various techniques described herein. It should be noted that non-transitory merely indicates that the media is tangible and not a signal.

The processing unit 604 may include at least one processing resource and may access computer-readable instructions 610 that may be stored in the storage 602. The processing unit 604 may be part of the network device, part of a network interface system, or both. The processing unit 604 may execute the computer-readable instructions 610 which may correspond to the method 200 described above. That is, blocks 612, 614, 616, 618, 620, 622, and 624 may correspond to instructions to perform blocks 202, 204, 206, 208, 210, 212, and 214, respectively.

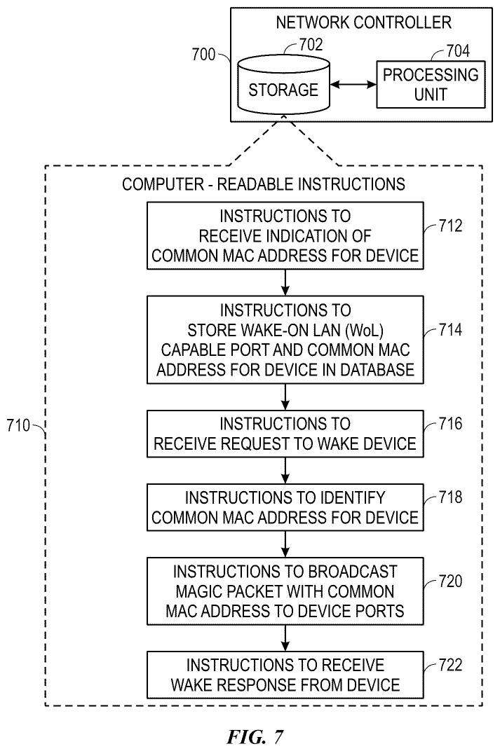

FIG. 7 illustrates components of an example network controller 700 that may include a storage 702 and a processing unit 704. The storage 702 may be any suitable article of manufacture that may serve as media to store processor-executable code, data, or the like. The processing unit 704 may include at least one processing resource and may access computer-readable instructions 710 that may be stored in the storage 702. The processing unit 704 may be part of the network device, part of a network interface system, or both. The processing unit 704 may execute the computer-readable instructions 710 which may correspond to the method 300 described above. That is, blocks 712, 714, 716, 718, 720, 722, and 724 may correspond to instructions to perform blocks 302, 304, 306, 308, 310, and 312, respectively.

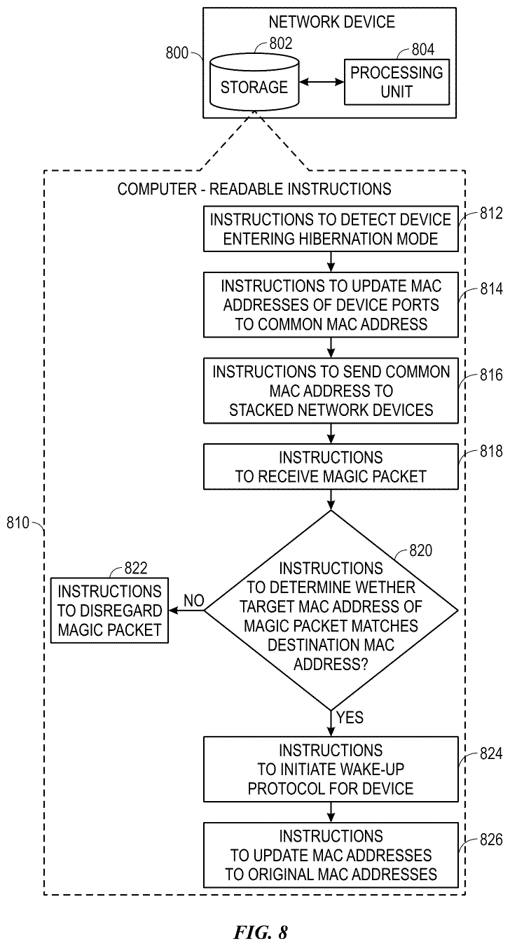

FIG. 8 illustrates components of an example network device 800 that may include a storage 802 and a processing unit 804. The storage 802 may be any suitable article of manufacture that may serve as media to store processor-executable code, data, or the like. The processing unit 804 may include at least one processing resource and may access computer-readable instructions 810 that may be stored in the storage 802. The processing unit 804 may be part of the network device, part of a network interface system, or both. The processing unit 804 may execute the computer-readable instructions 810 which may correspond to the method 400 described above. That is, blocks 812, 814, 816, 818, 820, 822, 824, and 826 may correspond to instructions to perform blocks 402, 404, 406, 408, 410, 412, 414, and 416, respectively.

As may be appreciated, the current techniques provide the ability for network controllers to send common magic packets to network devices to cause network devices to exit hibernation modes. That is, instead of sending individual magic packets to individual IO ports with specific MAC addresses to cause a respective network device to exit hibernation mode, the present techniques reduce the number of MAC addresses that may be tracked for waking network devices. In this way, a network controller may limit the memory or storage used to track MAC addresses for sending magic packets to different network devices. Further, if a WoL-capable port changes due to user modification or the like, the network controller may still be able to initiate the wake-up protocol for the device without updating the MAC address of the respective magic packet. Indeed, the current techniques enable a single magic packet to be used to activate a device regardless of the WoL-capable port that receives it. This feature becomes even more beneficial when applied to stacked network devices where a magic packet no longer needs to be sent to each device of the stacked network devices to activate. Indeed, after the network device of each stacked network device associates each WoL-capable port with a single MAC address, a single magic packet having the single MAC address can be used to activate any of the network devices of the stacked network devices.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A non-transitory, computer-readable medium, comprising computer-readable instructions that, when executed by at least one processing resource of a network device, cause the at least one processing resource to:
detect that the network device comprising one or more ports is entering a hibernation mode;
temporarily program the one or more ports of the network device to be associated with a first MAC address in response to detecting that the network device is entering the hibernation mode;
receive a packet configured to wake the network device, wherein the packet comprises a second MAC address;
determine whether the second MAC address is the same as the first MAC address; and
initiate a wake-up protocol of the network device in response to determining that the second MAC address is the same as the first MAC address.

2. The non-transitory, computer-readable medium of claim 1, wherein the packet is broadcast to a plurality of ports via a network, wherein at least one of the plurality of ports comprises at least one of the one or more ports of the network device.

3. The non-transitory, computer-readable medium of claim 1, wherein the network device comprises a network switch.

4. The non-transitory, computer-readable medium of claim 1, wherein the wake-up protocol comprises a Wake-on-LAN (WoL) protocol supported by the one or more ports of the network device.

5. The non-transitory, computer-readable medium of claim 1, wherein the first MAC address corresponds to a base MAC address associated with the network device.

6. The non-transitory, computer-readable medium of claim 1, wherein the computer-readable instructions that, when executed by the at least one processing resource, cause the at least one processing resource to temporarily program the one or more ports with the first MAC address by mapping one or more MAC addresses assigned to the one or more ports to the first MAC address.

7. The non-transitory, computer-readable medium of claim 1, wherein the computer-readable instructions that, when executed by the at least one processing resource, cause the at least one processing resource to detect that the network device is entering the hibernation mode based on a period of inactivity experienced by the network device being greater than a threshold amount of time.

8. The non-transitory, computer-readable medium of claim 1, comprising additional computer-readable instructions that, when executed by the at least one processing resource, further cause the at least one processing resource to program the one or more ports associated with the first MAC address to one or more additional MAC addresses after the wake-up protocol is initiated.

9. The non-transitory, computer-readable medium of claim 1, wherein each of the one or more ports corresponds to a respective unique MAC address prior to being temporarily programmed to be associated with the first MAC address.

10. The non-transitory, computer-readable medium of claim 9, comprising additional computer-readable instructions that, when executed by the at least one processing resource, further cause the at least one processing resource to program each of the one or more ports back to the respective unique MAC address after the wake-up protocol is initiated.

11. A network device, comprising:
a first plurality of ports configured to communicatively couple to an additional network device comprising a second plurality of ports via at least one of the first plurality of ports and at least one of the second plurality of ports; and
at least one processing resource configured to:
detect that the network device is entering a hibernation mode;
temporarily program the first plurality of ports and the second plurality of ports to be associated with a first MAC address in response to detecting that the additional network device is entering the hibernation mode;
receive a packet configured to wake the network device, the additional network device, or both, wherein the packet comprises a second MAC address;
determine whether the second MAC address is the same as the first MAC address; and
initiate a wake-up protocol of the network device in response to determining that the second MAC address is the same as the first MAC address.

12. The network device of claim 11, wherein the packet is received via one or more ports of the second plurality of ports.

13. The network device of claim 11, wherein each of the first plurality of ports and each of the second plurality of ports corresponds to a respective unique MAC address prior to being temporarily programmed to be associated with the first MAC address.

14. The network device of claim 13, wherein the at least one processing resource is configured to program each of the second plurality of ports back to the respective unique MAC address after the wake-up protocol is initiated.

15. The network device of claim 11, wherein the network device and the additional network device correspond to a first network switch and a second network switch, respectively.

16. The network device of claim 11, wherein the network device and the additional network device operate as part of a Virtual Switching Framework (VSF) stack.

17. A method, comprising:
temporarily programming, via at least one processing resource of a network device, a plurality of ports of the network device to be associated a first Media Access Control (MAC) address prior to the network device entering a hibernation mode;
receiving, via the at least one processing resource, a packet configured to initiate a wake-up protocol, wherein the packet comprises a second MAC address;
determining, via the at least one processing resource, whether the second MAC address is the same as the first MAC address; and
initiating, via the at least one processing resource, the wake-up protocol of the network device in response to determining that the second MAC address is the same as the first MAC address.

18. The method of claim 17, comprising temporarily programming an additional plurality of ports of an additional network device communicatively coupled to the at least one processing resource to be associated with the first MAC address prior to the network device entering the hibernation mode.

19. The method of claim 18, wherein the packet is configured to wake the additional network device in response to the second MAC address being the same as the first MAC address.

20. The method of claim 17, comprising operating in a normal mode prior to the network device entering the hibernation mode, wherein the normal mode corresponds to consuming an amount of power that is higher than operating in the hibernation mode.
